(19) United States
(12) Patent Application Publication
(10) Pub. No.: US 2014/0369289 A1
(43) Pub. Date: Dec. 18, 2014

(54) Transmission/Reception Coordination for Over-the-Air Communication Between Uncoordinated Base Stations of an Orthogonal Frequency-Division Multiplexing Based Cellular Radio Network

(71) Applicant: Broadcom Corporation, Irvine, CA (US)

(72) Inventors: Haiming Wang, Beijing (CN); Chunyan Gao, Beijing (CN)

(21) Appl. No.: 14/364,461

(22) PCT Filed: Dec. 12, 2011
(86) PCT No.: PCT/CN2011/083826

§ 371 Date: Jun. 12, 2014

(51) Int. Cl. H04L 5/00

(52) U.S. Cl. CPC H04L 5/003; H04L 27/2601
USPC 370/329

(57) ABSTRACT

The invention allows coordinating transmissions and receptions for over-the-air communication between uncoordinated base stations of an OFDM based cellular radio network. A radio resource dedicated for OTAC between uncoordinated base stations of an OFDM based cellular radio network is divided into subchannels. Deployment information of the uncoordinated base stations is obtained at a mobility management unit. Transmission allocation information is determined at the mobility management unit based on the obtained deployment information, the transmission allocation information comprising for each of the uncoordinated base stations their respective at least one symbol in said subframe of said dedicated radio resource and their respective at least one subchannel for use in their respective over-the-air communication transmissions, such that simultaneous over-the-air communication transmissions between an uncoordinated base station and its target uncoordinated base station are prevented. To the uncoordinated base stations are transmitted their respective determined transmission allocation information.

### BACKGROUND OF THE INVENTION

1. Field of the Invention

The invention relates generally to mobile communications. In particular, the invention relates to transmission/reception for over-the-air communication between uncoordinated base stations of an orthogonal frequency-division multiplexing based cellular radio network.

2. Description of the Related Art

Long Term Evolution (LTE) was introduced in release 8 of 3^{rd} Generation Partnership Project (3GPP) which is a specification for 3^{rd} generation mobile communication systems. LTE is a technique for mobile data transmission that aims to increase data transmission rates and decrease delays, among other things. LTE uses orthogonal frequency division multiple access (OFDMA) as its multiple access method in the downlink. The uplink uses single-carrier frequency division multiple access (SD-FDMA). 3GPP release 10 introduced a next version of LTE, named LTE Advanced (LTE-A), fulfilling 4^{th} generation system requirements.

Herein, the term “downlink” (DL) is used to refer to the link from the base station to the mobile device or user equipment, and the term “uplink” (UL) is used to refer to the link from the mobile device or user equipment to the base station.

In order to improve network coverage and to reduce costs, deployment of low-power base stations or “evolved Node Bs (eNBs)” (e.g. Home eNBs or pico cell eNBs) in local areas has emerged as a new trend in cellular networks, including LTE based cellular networks. These low-power eNBs may operate without an X2 interface, which case is referred to as “uncoordinated” deployment. For such uncoordinated local area deployment, it is expected that a dynamic frequency re-use mechanism may be beneficial.

For such a distributed scheme to work optimally, some information exchange between neighboring eNBs is needed. Such information exchange may relate e.g. to component carriers/physical resource blocks used by the different eNBs, power settings for different resources, time division duplex configurations in neighboring cells, some other configuration information, and the like.

However, as discussed above, in the case of uncoordinated deployment of low power eNBs, an X2 connection may not exist between these eNBs. Yet, they need to communicate somehow in order to allow the above discussed information exchange between neighboring eNBs. For such cases, a so called over-the-air communication (OTAC) has been proposed as a solution (see e.g. R1-091777, “Inter eNB over-the-air communication (OTAC) for LTE-Advanced”, 3GPP TSG RAN WG1 #57 Meeting, May 4-8, 2009 for details). The OTAC as defined herein is both in-band and inter-eNB.

The OTAC as defined herein requires a dedicated radio resource, and to avoid impact on user equipments (UEs) in a cell, the inter-eNB OTAC cannot operate in radio resources in which DL/UL for UEs are scheduled, or in which UE measurements are expected. Therefore, it has been proposed that the OTAC can be done e.g. in a guard period (GP) of a special subframe, or in a UL subframe, in order to avoid impact to UEs. Furthermore, it has been proposed that multimedia broadcast multicast service single frequency network (MBSFN) subframes may be utilized for this purpose.

However, even with the dedicated resource having been provided, there is still a further problem to solve: how to coordinate transmissions and receptions between the uncoordinated eNBs. It is obvious that if two eNBs transmit at same time, then they cannot detect each other even though the frequency they used can be different.

The present invention proposes a technical solution for non-contention based OTAC communication between the uncoordinated eNBs. The term “non-contention” refers to methods with more strict coordination between the eNBs to avoid collisions of OTAC transmission.

To summarize the problems of prior art, OTAC communication firstly needs dedicated resource; in the dedicated resource, transmission from different eNBs can be frequency-division multiplexed (FDM)/time-division multiplexed (TDM)/code-division multiplexed (CDM); and, for eNBs transmitting at same time, via FDM/CDM or via a same resource, they cannot detect each other correctly. TDM could solve this problem, but would cause further problems: pure TDM would cause the communication to last longer, and increase delay; and even for TDM, the eNB would still need to know when to send and when to receive, otherwise collisions would occur.

Accordingly, for the uncoordinated deployment without X2 interface, there is a need for a solution on how to coordinate the transmissions and receptions for the OTAC.

### SUMMARY OF THE INVENTION

A first aspect of the present invention is a method in which a subframe of a radio resource dedicated for over-the-air communication between uncoordinated base stations of an orthogonal frequency-division multiplexing (OFDM) based cellular radio network is divided into subchannels. Deployment information of the uncoordinated base stations is obtained at a mobility management unit of the cellular radio network. Transmission allocation information is determined at the mobility management unit based on the obtained deployment information, the transmission allocation information comprising for each of the uncoordinated base stations their respective at least one symbol in said subframe of said dedicated radio resource and their respective at least one subchannel for use in their respective over-the-air communication transmissions, such that simultaneous over-the-air communication transmissions between an uncoordinated base station and its target uncoordinated base station are prevented. To the uncoordinated base stations are transmitted their respective determined transmission allocation information.

A second aspect of the present invention is a computer program that comprises code adapted to cause the steps of the method of the first aspect when executed on a data-processing system. In an embodiment of the invention, the computer program may be stored on a computer readable medium.

A third aspect of the present invention is an apparatus which comprises a divider that is configured to divide a subframe of a radio resource dedicated for over-the-air communication between uncoordinated base stations of an orthogonal frequency-division multiplexing based cellular radio network into subchannels. The apparatus further comprises a deployment information unit that is configured to obtain deployment information of the uncoordinated base stations. The apparatus further comprises a processing unit that is configured to determine transmission allocation information based on the obtained deployment information, the transmission allocation information comprising for each of the uncoordinated base stations their respective at least one symbol in said subframe of said dedicated radio resource and their respective at least one subchannel for use in their respective over-the-air communication transmissions, such that simultaneous over-the-air communication transmissions between an uncoordinated base station and its target uncoordinated base station are prevented. The apparatus further comprises a transmitter that is configured to transmit to the uncoordinated base stations their respective determined transmission allocation information. In an embodiment, the apparatus may comprise a mobility management unit of the cellular radio network.

A fourth aspect of the present invention is an apparatus which comprises a dividing means for dividing a subframe of a radio resource dedicated for over-the-air communication between uncoordinated base stations of an orthogonal frequency-division multiplexing based cellular radio network into subchannels. The apparatus further comprises a deployment information means for obtaining deployment information of the uncoordinated base stations. The apparatus further comprises a processing means for determining transmission allocation information based on the obtained deployment information, the transmission allocation information comprising for each of the uncoordinated base stations their respective at least one symbol in said subframe of said dedicated radio resource and their respective at least one subchannel for use in their respective over-the-air communication transmissions, such that simultaneous over-the-air communication transmissions between an uncoordinated base station and its target uncoordinated base station are prevented. The apparatus further comprises a transmitting means for transmitting to the uncoordinated base stations their respective determined transmission allocation information. In an embodiment, the apparatus may comprise a mobility management unit of the cellular radio network.

A fifth aspect of the present invention is an uncoordinated base station that is configured to transmit the information about the target base stations in the over-the-air communication transmissions to the deployment information unit of the third aspect or the deployment information means of the fourth aspect.

In an embodiment of the invention, information about the subchannel division is provided to the uncoordinated base stations.

In an embodiment of the invention, the obtaining of the deployment information of the uncoordinated base stations comprises receiving information about target base stations in the over-the-air communication transmissions from the uncoordinated base stations.

In an embodiment of the invention, the obtaining of the deployment information of the uncoordinated base stations comprises obtaining position information of the uncoordinated base stations.

In an embodiment of the invention, the subframe of the radio resource dedicated for the over-the-air communication comprises a multimedia broadcast multicast service single frequency network (MBSFN) subframe.

In an embodiment of the invention, the transmission allocation information further comprises period and time offset information.

In an embodiment of the invention, the symbols are non-continuous.

In an embodiment of the invention, the cellular radio network is based on long term evolution technology. The term “long term evolution technology”, as used herein, is intended to cover the Long Term Evolution (LTE) introduced in release 8 of 3GPP, as well as any later revisions, such as LTE Advanced (LTE-A) introduced in 3GPP release 10.

It is to be understood that the aspects and embodiments of the invention described above may be used in any combination with each other. Several of the aspects and embodiments may be combined together to form a further embodiment of the invention. A method, an apparatus, or a computer program which is an aspect of the invention may comprise at least one of the embodiments of the invention described above.

The invention allows coordinating the transmissions and receptions for over-the-air communication between uncoordinated base stations of an orthogonal frequency-division multiplexing based cellular radio network. The invention allows avoiding collisions in OTAC signaling, and in some case, no assistant information is needed from each e-NB, thus the invention allows less of a signaling burden.

### BRIEF DESCRIPTION OF THE DRAWINGS

The accompanying drawings, which are included to provide a further understanding of the invention and constitute a part of this specification, illustrate embodiments of the invention and together with the description help to explain the principles of the invention. In the drawings:

FIG. 1 is a signaling diagram illustrating a method according to an embodiment of the present invention;

FIG. 2 is a block diagram illustrating an apparatus according to an embodiment of the present invention;

FIG. 3 illustrates a radio resource subframe divided in accordance with an embodiment of the present invention; and

FIG. 4 illustrates deployment of uncoordinated base stations in accordance with an embodiment of the present invention.

### DETAILED DESCRIPTION OF THE INVENTION

Reference will now be made in detail to the embodiments of the present invention, examples of which are illustrated in the accompanying drawings.

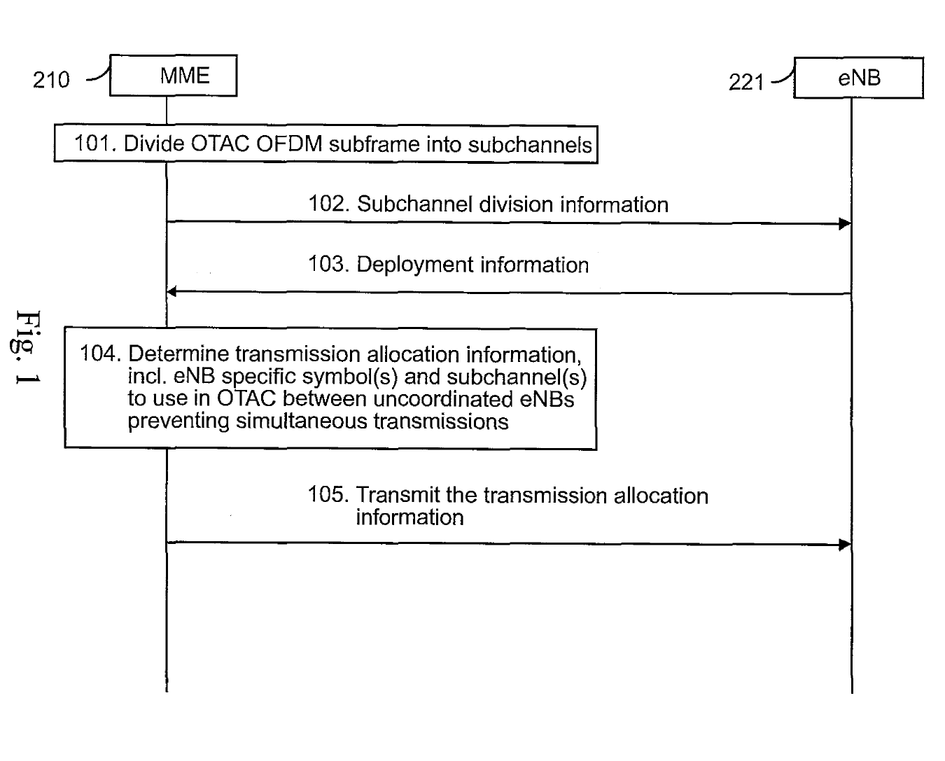

FIG. 1 is a signaling diagram illustrating a method according to an embodiment of the present invention.

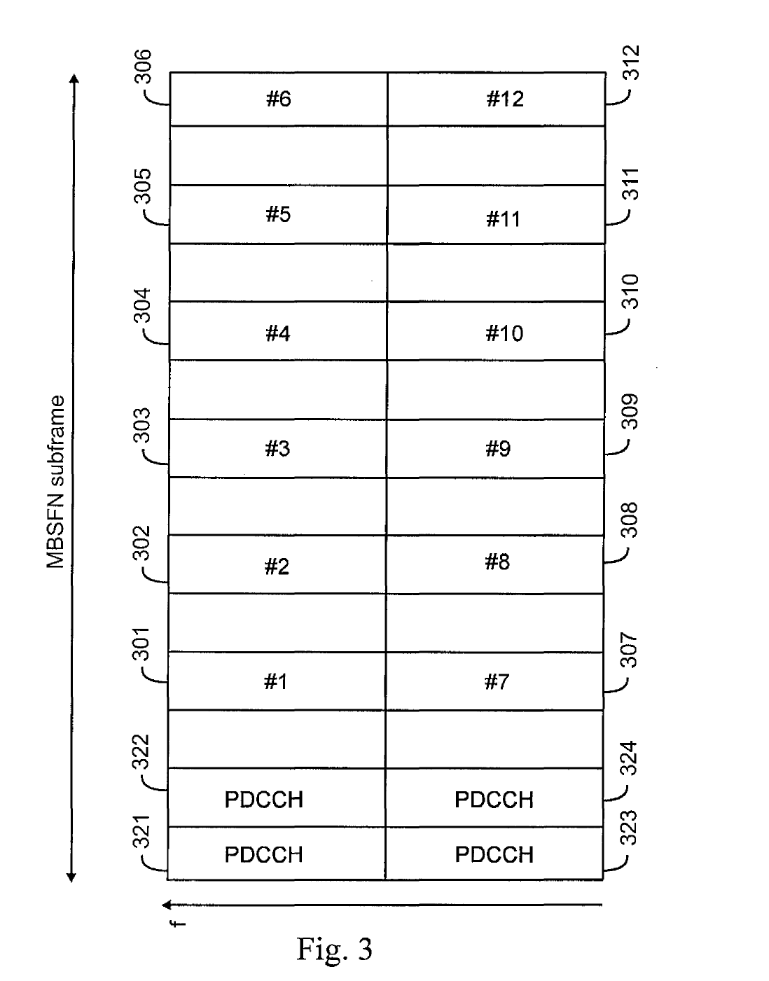

At step 101, a subframe of a radio resource dedicated for over-the-air communication between uncoordinated base stations 221-224 of an orthogonal frequency-division multiplexing (OFDM) based cellular radio network is divided into subchannels. In an embodiment, the subframe of the radio resource dedicated for the over-the-air communication comprises a multimedia broadcast multicast service single frequency network (MBSFN) subframe, as shown and further discussed in connection with FIG. 3. In an embodiment, the cellular radio network is based on long term evolution technology.

At step 102, information about the subchannel division is provided to the uncoordinated base stations 221-224.

At step 103, deployment information of the uncoordinated base stations 221-224 is obtained at a mobility management unit 210 of the cellular radio network. In an embodiment, the obtaining of the deployment information of the uncoordinated base stations comprises receiving information about target base stations in the over-the-air communication transmissions from the uncoordinated base stations 221-224. In another embodiment, the obtaining of the deployment information of the uncoordinated base stations 221-224 comprises obtaining position information of the uncoordinated base stations 221-224.

At step 104, transmission allocation information is determined at the mobility management unit 210 based on the obtained deployment information. The transmission allocation information comprises, for each of the uncoordinated base stations 221-224, their respective at least one symbol in the subframe of the dedicated radio resource and their respective at least one subchannel for use in their respective over-the-air communication transmissions, such that simultaneous over-the-air communication transmissions between an uncoordinated base station and its target uncoordinated base station are prevented. In an embodiment, the transmission allocation information further comprises period and time offset information. In an embodiment, the symbols are non-continuous.

At step 105, to the uncoordinated base stations 221-224 are transmitted their respective determined transmission allocation information.

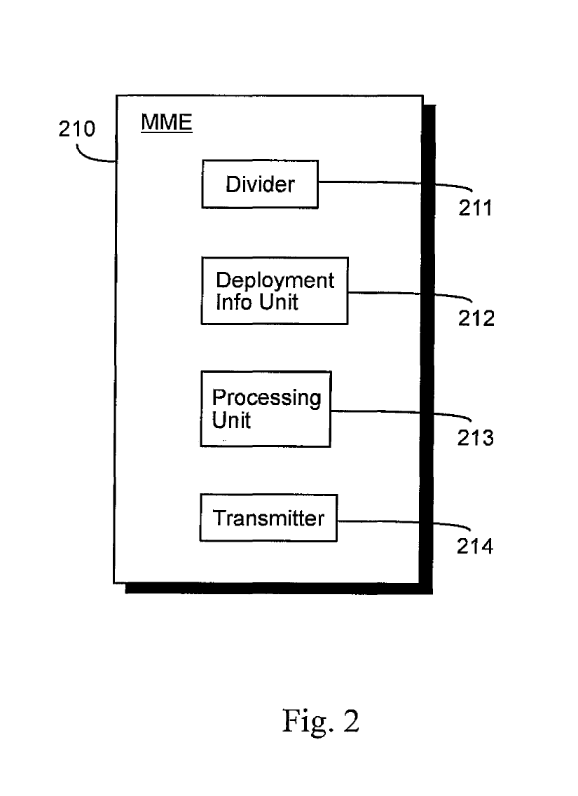

FIG. 2 is a block diagram illustrating an apparatus 210 according to an embodiment of the present invention. In an embodiment, the apparatus 210 may comprise a mobility management unit of an orthogonal frequency-division multiplexing (OFDM) based cellular radio network, such as a mobility management entity (MME). Furthermore, the cellular radio network may be based on long term evolution (LTE) technology, including LTE Advanced (LTE-A). The subframe of the radio resource dedicated for the over-the-air communication may comprise a multimedia broadcast multicast service single frequency network (MBSFN) subframe.

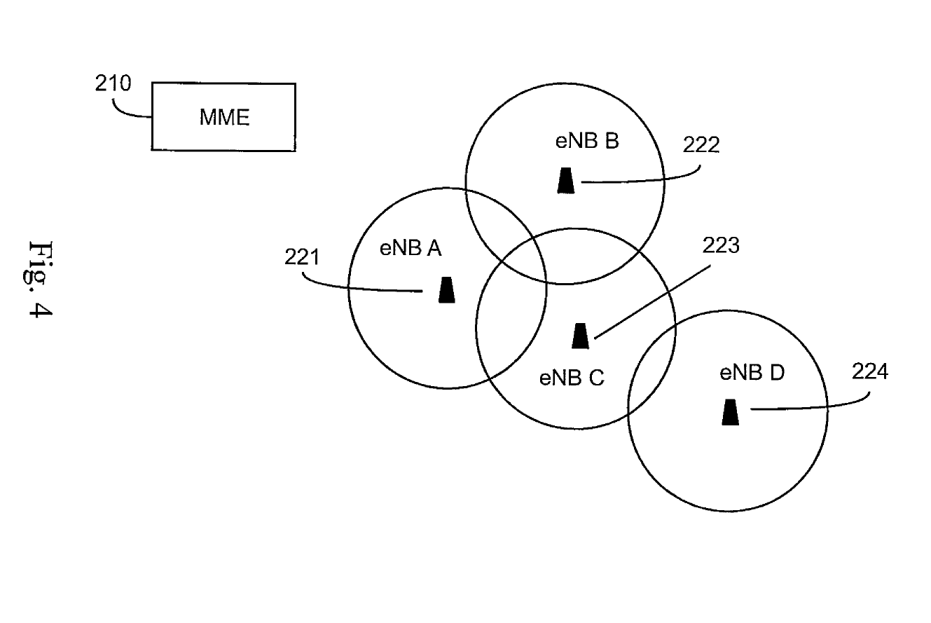

The apparatus 210 comprises a divider 211 that is configured to divide a subframe of a radio resource dedicated for over-the-air communication between uncoordinated base stations 221-224 (see FIG. 4) of an orthogonal frequency-division multiplexing based cellular radio network into subchannels. The subchannels may be e.g. time-, frequency- and/or code-division multiplexed subchannels.

The apparatus 210 further comprises a deployment information unit 212 that is configured to obtain deployment information of the uncoordinated base stations 221-224. The deployment information unit 212 may be further configured to perform the obtaining of the deployment information of the uncoordinated base stations 221-224 by receiving information about target base stations in the over-the-air communication transmissions from the uncoordinated base stations 221-224. Alternatively, the deployment information unit 212 may be further configured to perform the obtaining of the deployment information of the uncoordinated base stations 221-224 by obtaining position information of the uncoordinated base stations 221-224.

The apparatus 210 further comprises a processing unit 213 that is configured to determine transmission allocation information based on the obtained deployment information. As discussed above, the transmission allocation information comprises, for each of the uncoordinated base stations 221-224, their respective at least one symbol in the subframe of the dedicated radio resource and their respective at least one subchannel for use in their respective over-the-air communication transmissions, such that simultaneous over-the-air communication transmissions between an uncoordinated base station and its target uncoordinated base station are prevented. The transmission allocation information may further comprise period and time offset information. The symbols may be non-continuous.

The apparatus 210 further comprises a transmitter 214 that is configured to transmit to the uncoordinated base stations 221-224 their respective determined transmission allocation information. The transmitter 214 may be further configured to provide information about the subchannel division to the uncoordinated base stations 221-224.

FIG. 3 illustrates a radio resource subframe divided in accordance with an embodiment of the present invention. FIG. 3 shows an example of the subchannel division in the dedicated radio resource for OTAC. In the example of FIG. 3, the dedicated radio resource is comprised in a MBSFN subframe. More particularly, symbols other than the first two OFDM symbols 321-324 (which are for physical downlink control channel, i.e. PDCCH), are assumed as the dedicated OTAC resource. In this example, the radio resource for OTAC are divided into several symbols, and in each symbol, the radio resource is further divided in frequency domain into two sub-channels. To enable transmission/reception switching, the symbols for OTAC 301-312 are not continuous, as shown in FIG. 3.

FIG. 4 illustrates deployment of uncoordinated base stations in accordance with an embodiment of the present invention. FIG. 4 shows an example of low power eNB deployment, where eNB A, B, C 221-223 are neighbors of each other, and eNB D 224 is only a neighbor of eNB C 223. Assuming the position information is available at the apparatus 210, or the respective target OTAC eNB is informed to the apparatus 210 via signaling from each eNB 221-224, then the apparatus 210 can allocate a subchannel to avoid simultaneous transmission of OTAC signaling between neighboring eNBs. For example, the apparatus 210 can allocate subchannel #1 301 of FIG. 3 to eNB A 221 of FIG. 4, sub-channel #2 302 of FIG. 3 to eNB B 222 of FIG. 4, sub-channel #3 303 of FIG. 3 to eNB C 223 of FIG. 4, and sub-channel #7 307 of FIG. 3 to eNB D 224 of FIG. 4.

For eNBs which are not target OTAC receivers of each other, subchannels in a same time slot/symbol can be allocated. Furthermore, eNBs send OTAC information only in the time slot and sub-channel allocated by the apparatus 210, and may monitor OTAC signaling in other time slots/symbols in all the sub-channels.

The exemplary embodiments can include, for example, any suitable servers, workstations, PCs, laptop computers, Internet appliances, handheld devices, cellular telephones, smart phones, wireless devices, other devices, and the like, capable of performing the processes of the exemplary embodiments. The devices and subsystems of the exemplary embodiments can communicate with each other using any suitable protocol and can be implemented using one or more programmed computer systems or devices.

One or more interface mechanisms can be used with the exemplary embodiments, including, for example, Internet access, telecommunications in any suitable form (e.g., voice, modem, and the like), wireless communications media, and the like. For example, employed communications networks or links can include one or more wireless communications networks, cellular communications networks, 3G communications networks, Public Switched Telephone Network (PSTNs), Packet Data Networks (PDNs), the Internet, intranets, a combination thereof, and the like.

It is to be understood that the exemplary embodiments are for exemplary purposes, as many variations of the specific hardware used to implement the exemplary embodiments are possible, as will be appreciated by those skilled in the hardware and/or software art(s). For example, the functionality of one or more of the components of the exemplary embodiments can be implemented via one or more hardware and/or software devices.

The exemplary embodiments can store information relating to various processes described herein. This information can be stored in one or more memories, such as a hard disk, optical disk, magneto-optical disk, RAM, and the like. One or more databases can store the information used to implement the exemplary embodiments of the present inventions. The databases can be organized using data structures (e.g., records, tables, arrays, fields, graphs, trees, lists, and the like) included in one or more memories or storage devices listed herein. The processes described with respect to the exemplary embodiments can include appropriate data structures for storing data collected and/or generated by the processes of the devices and subsystems of the exemplary embodiments in one or more databases.

All or a portion of the exemplary embodiments can be conveniently implemented using one or more general purpose processors, microprocessors, digital signal processors, micro-controllers, and the like, programmed according to the teachings of the exemplary embodiments of the present inventions, as will be appreciated by those skilled in the computer and/or software art(s). Appropriate software can be readily prepared by programmers of ordinary skill based on the teachings of the exemplary embodiments, as will be appreciated by those skilled in the software art. In addition, the exemplary embodiments can be implemented by the preparation of application-specific integrated circuits or by interconnecting an appropriate network of conventional component circuits, as will be appreciated by those skilled in the electrical art(s). Thus, the exemplary embodiments are not limited to any specific combination of hardware and/or software.

Stored on any one or on a combination of computer readable media, the exemplary embodiments of the present inventions can include software for controlling the components of the exemplary embodiments, for driving the components of the exemplary embodiments, for enabling the components of the exemplary embodiments to interact with a human user, and the like. Such software can include, but is not limited to, device drivers, firmware, operating systems, development tools, applications software, and the like. Such computer readable media further can include the computer program product of an embodiment of the present inventions for performing all or a portion (if processing is distributed) of the processing performed in implementing the inventions. Computer code devices of the exemplary embodiments of the present inventions can include any suitable interpretable or executable code mechanism, including but not limited to scripts, interpretable programs, dynamic link libraries (DLLs), Java classes and applets, complete executable programs, Common Object Request Broker Architecture (CORBA) objects, and the like. Moreover, parts of the processing of the exemplary embodiments of the present inventions can be distributed for better performance, reliability, cost, and the like.

As stated above, the components of the exemplary embodiments can include computer readable medium or memories for holding instructions programmed according to the teachings of the present inventions and for holding data structures, tables, records, and/or other data described herein. Computer readable medium can include any suitable medium that participates in providing instructions to a processor for execution. Such a medium can take many forms, including but not limited to, non-volatile media, volatile media, transmission media, and the like. Non-volatile media can include, for example, optical or magnetic disks, magneto-optical disks, and the like. Volatile media can include dynamic memories, and the like. Transmission media can include coaxial cables, copper wire, fiber optics, and the like. Transmission media also can take the form of acoustic, optical, electromagnetic waves, and the like, such as those generated during radio frequency (RF) communications, infrared (IR) data communications, and the like. Common forms of computer-readable media can include, for example, a floppy disk, a flexible disk, hard disk, magnetic tape, any other suitable magnetic medium, a CD-ROM, CD±R, CD±RW, DVD, DVD-RAM, DVD±RW, DVD±R, HD DVD, HD DVD-R, HD DVD-RW, HD DVD-RAM, Blu-ray Disc, any other suitable optical medium, punch cards, paper tape, optical mark sheets, any other suitable physical medium with patterns of holes or other optically recognizable indicia, a RAM, a PROM, an EPROM, a FLASH-EPROM, any other suitable memory chip or cartridge, a carrier wave or any other suitable medium from which a computer can read.

While the present inventions have been described in connection with a number of exemplary embodiments, and implementations, the present inventions are not so limited, but rather cover various modifications, and equivalent arrangements, which fall within the purview of prospective claims.

1. A method, comprising:
dividing a subframe of a radio resource dedicated for over-the-air communication between uncoordinated base stations of an orthogonal frequency-division multiplexing based cellular radio network into subchannels;
obtaining, at a mobility management unit of the cellular radio network, deployment information of the uncoordinated base stations;
determining transmission allocation information at the mobility management unit based on the obtained deployment information, the transmission allocation information comprising for each of the uncoordinated base stations their respective at least one symbol in said subframe of said dedicated radio resource and their respective at least one subchannel for use in their respective over-the-air communication transmissions, such that simultaneous over-the-air communication transmissions between an uncoordinated base station and its target uncoordinated base station are prevented; and
transmitting to the uncoordinated base stations their respective determined transmission allocation information.

2. The method according to claim 1, further comprising:
providing information about the subchannel division to the uncoordinated base stations.

3. The method according to claim 1, wherein the obtaining of the deployment information of the uncoordinated base stations comprises receiving information about target base stations in the over-the-air communication transmissions from the uncoordinated base stations.

4. The method according to claim 1, wherein the obtaining of the deployment information of the uncoordinated base stations comprises obtaining position information of the uncoordinated base stations.

5. The method according to claim 1, wherein the subframe of the radio resource dedicated for the over-the-air communication comprises a multimedia broadcast multicast service single frequency network subframe.

6. The method according to claim 1, wherein the transmission allocation information further comprises period and time offset information.

7. The method according to claim 1, wherein the symbols are non-continuous.

8. The method according to claim 1, wherein the cellular radio network is based on long term evolution technology.

9. A non-transitory computer readable memory storing a computer program, the computer program comprising code to:
divide a subframe of a radio resource dedicated for over-the-air communication between uncoordinated base stations of an orthogonal frequency-division multiplexing based cellular radio network into subchannels;
obtain, at a mobility management unit of the cellular radio network, deployment information of the uncoordinated base stations;
determine transmission allocation information at the mobility management unit based on the obtained deployment information, the transmission allocation information comprising for each of the uncoordinated base stations their respective at least one symbol in said subframe of said dedicated radio resource and their respective at least one subchannel for use in their respective over-the-air communication transmissions, such that simultaneous over-the-air communication transmissions between an uncoordinated base station and its target uncoordinated base station are prevented; and
transmit to the uncoordinated base stations their respective determined transmission allocation information.

10. (canceled)

11. An apparatus, comprising:
a divider configured to divide a subframe of a radio resource dedicated for over-the-air communication between uncoordinated base stations of an orthogonal frequency-division multiplexing based cellular radio network into subchannels;
a deployment information unit configured to obtain deployment information of the uncoordinated base stations;
a processing unit configured to determine transmission allocation information based on the obtained deployment information, the transmission allocation information comprising for each of the uncoordinated base stations their respective at least one symbol in said subframe of said dedicated radio resource and their respective at least one subchannel for use in their respective over-the-air communication transmissions, such that simultaneous over-the-air communication transmissions between an uncoordinated base station and its target uncoordinated base station are prevented; and
a transmitter configured to transmit to the uncoordinated base stations their respective determined transmission allocation information.

12. The apparatus according to claim 11, wherein the transmitter is further configured to provide information about the subchannel division to the uncoordinated base stations.

13. The apparatus according to claim 11, wherein the deployment information unit is further configured to receive information about target base stations in the over-the-air communication transmissions from the uncoordinated base stations.

14. The apparatus according to claim 11, wherein the deployment information unit is further configured to obtain position information of the uncoordinated base stations.

15. The apparatus according to claim 11, wherein the subframe of the radio resource dedicated for the over-the-air communication comprises a multimedia broadcast multicast service single frequency network subframe.

16. The apparatus according to claim 11, wherein the transmission allocation information further comprises period and time offset information.

17. The apparatus according to claim 11, wherein the symbols are non-continuous.

18. The apparatus according to claim 11, wherein the apparatus comprises a mobility management unit of the cellular radio network.

19. The apparatus according to claim 11, wherein the cellular radio network is based on long term evolution technology.

20. An uncoordinated base station, configured to transmit the information about the target base stations in the over-the-air communication transmissions to the deployment information unit of claim 13.

21. The computer readable memory according to claim 9, the computer program code comprising code to:
provide information about the subchannel division to the uncoordinated base stations.
